(19) United States
(12) Patent Application Publication
(10) Pub. No.: US 2021/0117799 A1
(43) Pub. Date: Apr. 22, 2021

(54) MONITORING PERFORMANCE OF A STORAGE SYSTEM USING PAIRED NEURAL NETWORKS

(71) Applicant: EMC IP Holding Company LLC, Hopkinton, MA (US)

(72) Inventors: Sorin Faibish, Newton, MA (US); Istvan Gonczi, Berkley, MA (US); Ivan Bassov, Brookline, MA (US)

(21) Appl. No.: 16/656,193

(22) Filed: Oct. 17, 2019

(51) Int. Cl. G06N 3/08; G06N 3/04

(52) U.S. Cl. CPC G06N 3/082; G06N 3/0454

(57) ABSTRACT

A method of monitoring storage performance of a remote data storage apparatus (DSA) is provided. The method includes (a) receiving performance metrics of the DSA and a first set of behavioral estimates generated by a first neural network (NN) running on the DSA operating on the performance metrics; (b) operating a second NN on the computing device with the received performance metrics as inputs, the second NN configured to produce a second set of behavioral estimates as outputs in response to the performance metrics, the second NN running at a higher level of precision than the first NN; and (c) sending to the remote DSA updated parameters of an updated version of the first NN based at least in part on the performance metrics and the first and second sets of behavioral estimates. Apparatuses, systems, and computer program products for performing similar methods are also provided.

### BACKGROUND

Data storage systems are arrangements of hardware and software in which storage processors are coupled to arrays of non-volatile storage devices, such as magnetic disk drives, electronic flash drives, and/or optical drives. The storage processors service storage requests arriving from host machines (“hosts”), which specify blocks, files, and/or other data elements to be written, read, created, deleted, etc. Software running on the storage processors manages incoming storage requests and performs various data processing tasks to organize and secure the data elements on the non-volatile storage devices.

Performance metrics are often employed in data storage systems. Certain performance metrics of data storage systems may be measured directly, while other, such as behavioral metrics are more complicated to measure. Such behavioral metrics may be estimated in various ways from the directly measured metrics. Behavioral metrics may be estimated using analytical formulas or trained neural networks.

The foregoing background is presented for illustrative purposes to assist the reader in readily understanding the background in which the invention was developed. However, the foregoing background is not intended to set forth any admission that any particular subject matter has the legal effect of prior art.

### SUMMARY

Conventional approaches to estimating the behavioral metrics may suffer from deficiencies. Although analytical formulas may produce fast results without using many processing resources, trained neural networks tend to produce more accurate results. Unfortunately, the data representing these trained neural networks is often quite large, requiring a large amount of memory and processing resources to run. Therefore, administrators are often reluctant to run neural networks on their data storage systems, as the neural networks can compete for resources with the storage system's main task of servicing I/O requests. Instead of the neural networks running on the data storage systems themselves, they could be run on a remote server. However, such an approach may result in considerable latency in receiving results.

Thus, it would be desirable to operate a data storage system that is able to estimate its behavioral performance metrics accurately using a neural network but without suffering from either high latency or high utilization of data storage system resources. This result may be accomplished by running a full neural network on a remote server and creating a scaled-down version of that full neural network to run on the data storage system itself. The scaled-down version may be a neural network that runs at a lower level of numerical precision. For example, the neural network may be “discretized,” in which synapses of the full neural network are either eliminated if their weights are below a threshold or converted into simple unweighted synapses if their weights are above the threshold. In effect, the original floating point representation of the synapse's weight is rounded to an integer representation with only two distinct values (1 and 0). This discretization allows many nodes of the full neural network to be eliminated in the scaled-down version, reducing the memory footprint on the data storage system. In addition, both the reduced size and the elimination of weighting allows the scaled-down neural network to be operated using far fewer processing resources. Further, a discretized representation allows the use of integer math for any necessary calculations on the discretized neural network rather than much slower floating point math used by the full neural network. The full neural network is still available to check the accuracy of the results, while the scaled-down version is still able to produce a sufficiently accurate approximation in real-time or near real-time. In addition, the scaled-down version is able to receive updates in response to continued training of the full neural network.

In one embodiment, a method is performed by a computing device for monitoring storage performance of a remote data storage apparatus (DSA). The method includes (a) receiving performance metrics of the DSA and a first set of behavioral estimates generated by a first neural network (NN) running on the DSA operating on the performance metrics; (b) operating a second NN on the computing device with the received performance metrics as inputs, the second NN configured to produce a second set of behavioral estimates as outputs in response to the performance metrics, the second NN running at a higher level of precision than the first NN; and (c) sending to the remote DSA updated parameters of an updated version of the first NN based at least in part on the performance metrics and the first and second sets of behavioral estimates. An apparatus and computer program product for performing a similar method are also provided.

In one embodiment, a method is performed by a computerized apparatus for monitoring storage performance of the apparatus. The method includes (1) operating a first neural network (NN) on the apparatus with performance metrics of the apparatus as inputs, the first NN configured to produce a first set of behavioral estimates as outputs in response to the performance metrics; (2) sending the performance metrics and the first set of behavioral estimates to a remote computing device configured to run a second NN, the second NN configured to produce a second set of behavioral estimates as outputs in response to the performance metrics, the second NN running at a higher level of precision than the first NN; (3) receiving updated parameters of the first NN from the remote computing device in response to the remote computing device updating the first NN based at least in part on the performance metrics and the first and second sets of behavioral estimates; and (4) updating the first NN with the received updated parameters and operating the updated first NN on the apparatus to produce additional behavioral estimates. An apparatus and computer program product for performing a similar method are also provided.

In one embodiment, a system is provided. The system includes (I) a plurality of computerized data storage apparatuses (DSAs) and (II) a remote computing device remote from the DSAs. Each DSA is configured to (A) operate a first neural network (NN) on that DSA with performance metrics of that DSA as inputs, the first NN configured to produce a first set of behavioral estimates as outputs in response to the performance metrics; (B) send the performance metrics and the first set of behavioral estimates to the remote computing device; (C) receive updated parameters of the first NN from the remote computing device; and (D) update the first NN with the received updated parameters and operate the updated first NN on that DSA to produce additional behavioral estimates. The remote computing device is configured to, for each DSA, (i) receive the performance metrics and the first set of behavioral estimates from that DSA; (ii) operate a second NN for that DSA with the received performance metrics as inputs, the second NN configured to produce a second set of behavioral estimates as outputs in response to the performance metrics, the second NN running at a higher level of precision than the first NN; and (iii) send to that DSA updated parameters of an updated version of the first NN based at least in part on the performance metrics and the first and second sets of behavioral estimates.

The foregoing summary is presented for illustrative purposes to assist the reader in readily grasping example features presented herein. However, the foregoing summary is not intended to set forth required elements or to limit embodiments hereof in any way.

### BRIEF DESCRIPTION OF THE SEVERAL VIEWS OF THE DRAWINGS

The foregoing and other features and advantages will be apparent from the following description of particular embodiments of the invention, as illustrated in the accompanying drawings, in which like reference characters refer to the same or similar parts throughout the different views.

FIG. 1 is a block diagram depicting an example system, apparatus, and data structure arrangement for use in connection with various embodiments.

FIG. 2 is a flowchart depicting an example method according to various embodiments.

FIG. 3 is a flowchart depicting example methods according to various embodiments.

FIG. 4 is a block diagram depicting example data structure arrangements for use in connection with various embodiments.

FIG. 5 is a sequence diagram depicting example methods according to various embodiments.

### DETAILED DESCRIPTION OF THE INVENTION

Embodiments are directed to techniques for operating a data storage system that is able to estimate its behavioral performance metrics accurately using a neural network but without suffering from either high latency or high utilization of data storage system resources. This result may be accomplished by running a full neural network on a remote server and creating a scaled-down version of that full neural network to run on the data storage system itself. The scaled-down version may be a neural network that runs at a lower level of numerical precision. For example, the neural network may be “discretized,” in which synapses of the full neural network are either eliminated if their weight are below a threshold or converted into simple unweighted synapses if their weight are above the threshold. In effect, the original floating point representation of the synapse's weight is rounded to an integer representation with only two distinct values (1 and 0). This discretization allows many nodes of the full neural network to be eliminated in the scaled-down version, reducing the memory footprint on the data storage system. In addition, both the reduced size and the elimination of weighting allows the scaled-down neural network to be operated using far fewer processing resources. Further, a discretized representation allows the use of integer math for any necessary calculations on the discretized neural network rather than much slower floating point math used by the full neural network. The full neural network is still available to check the accuracy of the results, while the scaled-down version is still able to produce a sufficiently accurate approximation in real-time or near real-time. In addition, the scaled-down version is able to receive updates in response to continued training of the full neural network.

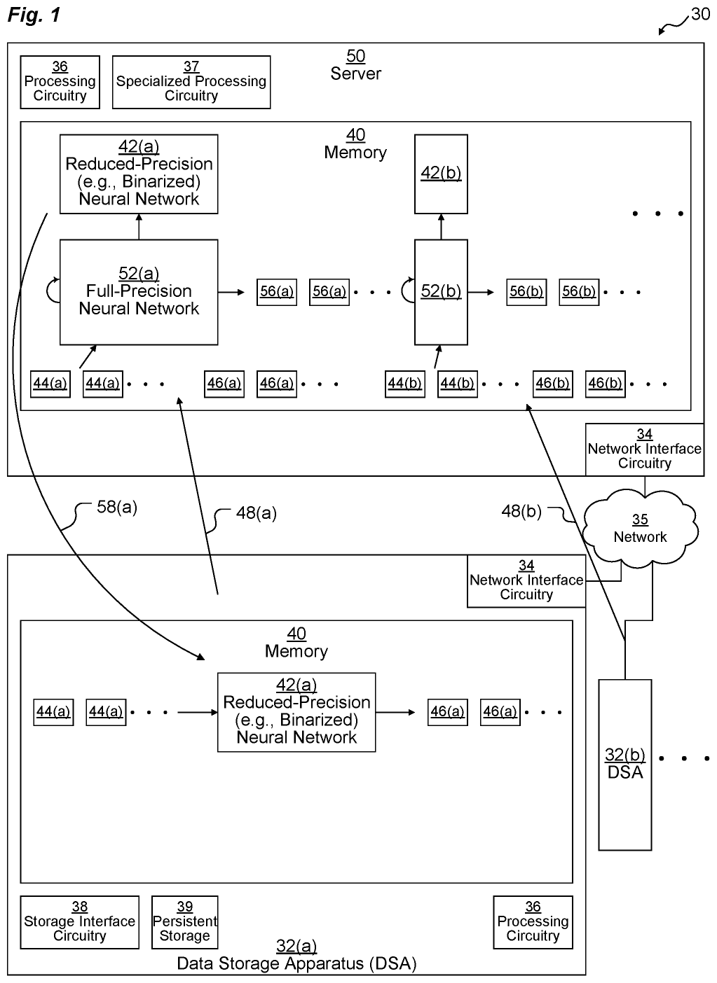

FIG. 1 depicts an example environment 30. Environment 30 may include a server 50 and one or more data storage apparatus (DSA) computing devices 32 (depicted as DSAs 32(a), 32(b), . . . ). The server 50 and each DSA 32 may be any kind of computing device or collection (or cluster) of computing devices, such as, for example, a personal computer, workstation, server computer, enterprise server, data storage array device, laptop computer, tablet computer, smart phone, mobile computer, etc. Typically, the server 50 is an enterprise server, and the DSAs 32 are data storage array devices, such as for example, block-based and/or file-based data storage arrays.

The server 50 and each DSA 32 at least include network interface circuitry 34, processing circuitry 36, and memory 40, as well as interconnection circuitry and various other circuitry and parts (not depicted).

Network interface circuitry 34 may include one or more Ethernet cards, cellular modems, Fibre Channel (FC) adapters, Wireless Fidelity (Wi-Fi) wireless networking adapters, and/or other devices for connecting to a network 35. Network 35 may include a LAN, WAN, VPN, cellular network, wireless network, the Internet, other types of computer networks, and various combinations thereof.

Processing circuitry 36 may be any kind of processor or set of processors configured to perform operations, such as, for example, a microprocessor, a multi-core microprocessor, a digital signal processor, a system on a chip, a collection of electronic circuits, a similar kind of controller, or any combination of the above. Processing circuitry is typically general-purpose, for performing various types of processing. In some embodiments, server 50 also includes specialized processing circuitry 37, such as, for example, a graphical processing unit (GPU) or general-purpose GPU (GPGPU) like an NVIDIA GEFORCE GPU or an AMD RADEON GPU. In some embodiments, a DSA 32 does not include such specialized processing circuitry 37.

Memory 40 may include any kind of digital system memory, such as, for example, random access memory (RAM). Memory 40 stores an operating system (OS, not depicted, such as, for example, a Linux, UNIX, Windows, MacOS, or similar operating system) as well as various drivers and applications (not depicted) in operation. Memory 40 may also store various other data structures used by the OS, drivers, and applications.

Each DSA 32 includes storage interface circuitry 38 and persistent data storage 39. Storage interface circuitry 38 controls and provides access to the persistent storage 39. Storage interface circuitry 38 may include, for example, SCSI, SAS, ATA, SATA, FC, M.2, and/or other similar controllers and ports. Persistent storage 39 may be made up of one or more persistent storage devices, such as, for example, magnetic disks, flash drives, solid-state storage drives, or other types of storage drives.

In some embodiments, memory 40 may also include a persistent storage portion (not depicted). Persistent storage portion of memory 40 may be made up of one or more persistent storage devices, such as, for example, magnetic disks, flash drives, solid-state storage drives, or other types of storage drives. Persistent storage portion of memory 40 or persistent storage 39 is configured to store programs and data even while the computing device 32 is powered off. The OS, applications, and drivers are typically stored in this persistent storage portion of memory 40 or persistent storage 39 so that they may be loaded into a system portion of memory 40 upon a system restart or as needed. The various applications, when stored in non-transitory form either in the volatile portion of memory 40 or in the persistent portion of memory 40 or in persistent storage 39, each form a computer program product. The processing circuitry 36, 37 running one or more applications thus forms a specialized circuit constructed and arranged to carry out the various processes described herein.

Each DSA 32 operates an I/O driver stack (not depicted) to process data storage commands with respect to the persistent storage 39.

Server 50 includes a full-precision neural network 52 (depicted as full-precision neural networks 52(a), 52(b), . . . ) for each DSA 32. Each full-precision neural network 52 includes various nodes and interconnecting weighted synapses (not depicted) and is configured to receive a set of performance metrics 44 (depicted as performance metrics 44(a), 44(b), . . . ) for a particular DSA 32 as input values. The full-precision neural network 52 is configured to operate on those input values and to produce behavioral estimates 56 (depicted as behavioral estimates 56(a), 56(b), . . . ) for the particular DSA 32 as output values.

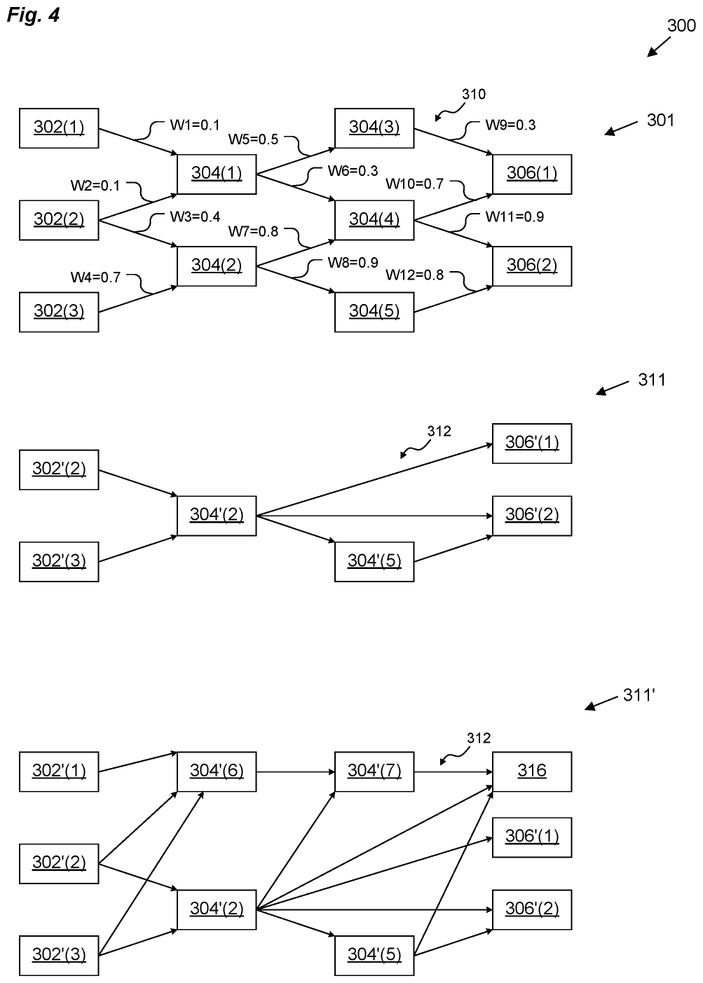

Each DSA 32 also includes a reduced-precision neural network 42 (for example, reduced-precision neural network 42(a) for DSA 32(a)). Each reduced-precision neural network 42 is configured to operate on the set of performance metrics 44 of its DSA 32 as input values and to produce behavioral estimates 46 (depicted as behavioral estimates 46(a), 46(b), . . . ) for the DSA 32 as output values. Each reduced-precision neural network 42 is a scaled-down version of the corresponding full-precision neural network 52 from the server 50. Typically, the reduced-precision neural network 42 includes fewer nodes and synapses (not depicted) than the corresponding full-precision neural network 52, allowing it to be stored fully in memory 40. The synapses of the reduced-precision neural network 42 have a lower level of numerical precision than the synapses of the full-precision neural network 52. In one embodiment, in which the reduced-precision neural network 42 is “discretized,” each synapse of the reduced-precision neural network 42 is unweighted, allowing faster processing. An example full-precision neural network 52 and corresponding reduced-precision neural network 42 are described in more detail below in connection with FIG. 4.

In some embodiments, although the full-precision neural network 52 includes many nodes and synapses operating at a high degree of numerical precision (e.g., 64-bit floating point), operation can be accelerated by running on the specialized processing circuitry 37 of the server 50. This allows the server 50 to operate full-precision neural networks 52 for many DSAs 32.

Behavioral estimates 46 are not as accurate as behavioral estimates 56, but they are still accurate enough for many purposes.

In operation, a DSA 32 runs its reduced-precision neural network 42 operating on its performance metrics 44 as inputs, yielding behavioral estimates 46 as outputs. DSA 32 may then use those behavioral estimates 46 for various purposes, such as displaying to a user and adjusting its operation, as needed. For example, the behavioral estimates 46 may include a compression ratio (or, more generally, a data reduction ratio), and the DSA 32 may use that compression ratio or data reduction ratio to calculate how much to throttle incoming writes.

DSA 32 also sends a signal 48 (depicted as signals 48(a), 48(b)) to the server 50, including the set of performance metrics 44 and the corresponding set of behavioral estimates 46. In response the server 50 operates its full-precision neural networks 52 for that DSA 32 on the performance metrics 44 as inputs, yielding behavioral estimates 56 as outputs. Server 50 may compare the behavioral estimates 46, 56, and if they differ significantly, server 50 may update the reduced-precision neural network 42 for that DSA 32. In some embodiments, this may also include updating the full-precision neural networks 52 for that DSA 32, such as by running machine learning techniques. If an update is performed, server 50 sends an update signal 58 back to the DSA 32 including updated parameters (e.g., a topology and set of activation functions for each node) of the reduced-precision neural network 42 for that DSA 32.

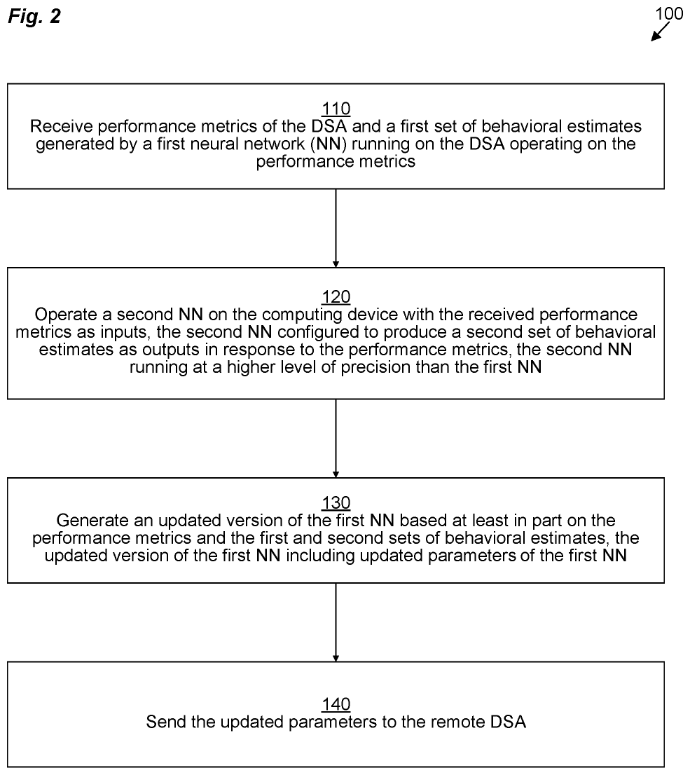

FIG. 2 illustrates an example method 100 performed by server 50 for monitoring storage performance of a remote DSA 32. It should be understood that any time a piece of software is described as performing a method, process, step, or function, what is meant is that a computing device 32, 50 on which that piece of software is running performs the method, process, step, or function when executing that piece of software on its processing circuitry 36, 37. It should be understood that one or more of the steps or sub-steps of method 100 may be omitted in some embodiments. Similarly, in some embodiments, one or more steps or sub-steps may be combined together or performed in a different order.

In step 110, server 50 receives performance metrics 44 of the DSA 32 and a first set of behavioral estimates 46 generated by a first neural network (e.g., reduced-precision neural network 42) running on the DSA 32 operating on the performance metrics 44.

In step 120, server 50 operates a second neural network (e.g., full-precision neural network 52) with the received performance metrics 44 as inputs, the second neural network configured to produce a second set of behavioral estimates 56 as outputs in response to the performance metrics 44, the second neural network running at a higher level of precision than the first neural network. In some embodiments, step 120 is performed on specialized processing circuitry 37.

In step 130, server 50 generates an updated version of the first neural network based at least in part on the performance metrics 44 and the first and second sets of behavioral estimates 46, 56. The updated version of the first neural network includes updated parameters of the first neural network. In some embodiments, step 130 may be illustrated with respect to FIG. 4.

FIG. 4 illustrates an example arrangement 300 of a full-precision neural network 52 and its corresponding reduced-precision neural network 42. In FIG. 4, an example arrangement 301 of a full-precision neural network 52 is shown. Arrangement 301 includes several input nodes 302 (depicted as input nodes 302(1), 302(2), 302(3)), corresponding to the inputs from performance metrics 44. Arrangement 301 also includes several output nodes 306 (depicted as output nodes 306(1), 306(2)), corresponding to the outputs of behavioral estimates 56. Arrangement 301 also includes several hidden nodes 304 (depicted as hidden nodes 304(1), 304(2), 304(3), 304(4), 304(5)) interposing between input nodes 302 and output nodes 306. Various nodes 302, 304, 306 are connected by full-precision synapses 310, each having a respective weight (depicted as weights W1-W12). In some embodiments, the weights W1-W12 are 64-bit or other high-precision floating point values.

In FIG. 4, an example arrangement 311 of a reduced-precision neural network 42 generated from the arrangement 301 of full-precision neural network 52 is also shown. In some embodiments, the weights of synapses 310 from arrangement 301 are compared to a threshold value (e.g., 0.2). If the weight exceeds the threshold, then the synapse 310 is maintained, but if the weight does not exceed the threshold (or is ≤the threshold), then that synapse 310 is not used in arrangement 311. For example, because the synapses 310 with weight W1 and W2 have weights less than 0.2, those synapses 310 are not used in arrangement 311. As a result hidden node 304(1) no longer has any inputs, so node 304(1) is also not used in arrangement 311. Because hidden node 304(1) is not used, hidden node 304(3) also has no inputs, so hidden node 304(3) is also not used in arrangement 311. Node 302(2) becomes node 302′(2) in arrangement 311, node 302(3) becomes 302′(3), node 304(2) becomes 304′(2), etc.

Other synapses 310, with weights W3, W4, W7, W8, W10, W11, W12 may be maintained as unweighted synapses 312 in arrangement 311 since they have values above the threshold of 0.2. In some embodiments, as depicted, since hidden node 304(4) would only have one input synapse 312 in arrangement 311, hidden node 304(4) is not used in arrangement 311, and synapses 312 are instead inserted directly between nodes 304′(2) and 306′(1) and between nodes 304′(2) and 306′(2).

In some embodiments, an alternative arrangement 311′ of the reduced-precision neural network 42 is generated including a confidence value 316 as an additional output. Thus, input node 302(1) is maintained as input node 302′(1), and additional hidden nodes 304′(6), 304′(7) are added, together with corresponding unweighted synapses 312 to generate new output node 316. Confidence value 316 indicates how likely the output nodes 306′ are to be close in value to the output nodes 306. If this value is below a confidence threshold (e.g., 0.8), then the values output nodes 306′ may be ignored, and the DSA 32 may instead choose to ask the server 50 for the values of its output nodes 306.

In some embodiments, confidence value 316 may be an array of values. In these embodiments, each value of the array corresponds to a respective one of the other output nodes 306′, indicating whether or not that output value 306′ is to be ignored or not. Thus, in these embodiments, each array value may be zero or all ones (e.g., 11111111), allowing them to be XORed with the values of the other output nodes 306′ to quickly identify invalid results.

Returning to FIG. 2, in step 140, server 50 sends the updated parameters to the remote DSA 32 so that the remote DSA 32 can reconstruct the updated reduced-precision neural network 42 (e.g., arrangement 311, 311′).

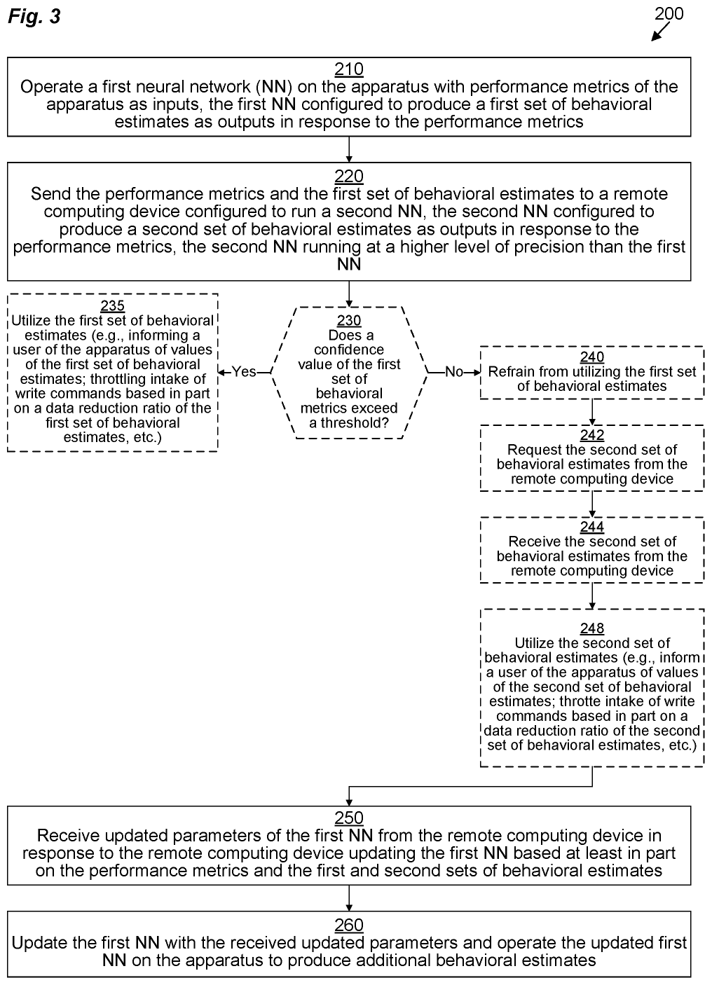

FIG. 3 depicts a method 200 performed by a computerized apparatus (e.g., DSA 32) of monitoring storage performance of the computerized apparatus.

In step 210, DSA 32 operates a first neural network (e.g., reduced-precision neural network 42) with performance metrics 44 of the DSA 32 as inputs. The first neural network is configured to produce a first set of behavioral estimates 46 as outputs in response to the performance metrics 44. In some embodiments, the performance metrics 44 may initially be converted from floating point values into integer values so that integer mathematical operations may be utilized throughout the neural network 42, thereby speeding up operation.

In step 220, DSA 32 sends the performance metrics 44 and the first set of behavioral estimates 46 to a remote computing device (e.g., server 50) configured to run a second neural network (e.g., full-precision neural network 52). The second neural network 52 is configured to produce a second set of behavioral estimates 56 as outputs in response to the performance metrics 44. In addition, the second neural network 52 runs at a higher level of precision than the first neural network 42.

In some embodiments, optional steps 230-248 may be performed. In step 230, DSA 32 determines whether or not a confidence value 316 of the behavioral metrics 46 exceeds a confidence threshold. If it does, then operation proceeds with step 235, in which the DSA 32 utilizes the first set of behavioral estimates 46 (e.g., informing a user of the DSA 32 of values of the first set of behavioral estimates and/or throttling intake of write commands based in part on a data reduction ratio of the first set of behavioral estimates 46, etc.). Otherwise, operation proceeds with steps 240-248, in which the behavioral estimates 46 are not used by the DSA 32 (step 240), the DSA 32 instead requesting (step 242) and receiving (step 244) the behavioral estimates 56 generated by the full-precision neural network 52 from the server 50 to be used instead of the first set of behavioral estimates 46 (step 248). In some embodiments, steps 230-248 are performed separately for each output value 306′ of the behavioral metrics 46, the confidence value 316 being an array of values.

In any case, operation may proceed with step 250. It should be understood that step 250 may not always follow step 220. Thus, step 250 is only performed if the server 50 generates an updated version of reduced-precision neural network 42. In step 250, DSA 32 receives updated parameters of the first neural network 42 from the server 50 in response to the server 50 updating the first neural network 42 based at least in part on the performance metrics and the first and second sets of behavioral estimates 46, 56.

In step 260, DSA 32 updates the first neural network 42 with the received updated parameters and operates the updated first neural network 42 on the DSA 32 to produce additional behavioral estimates 46 going forward.

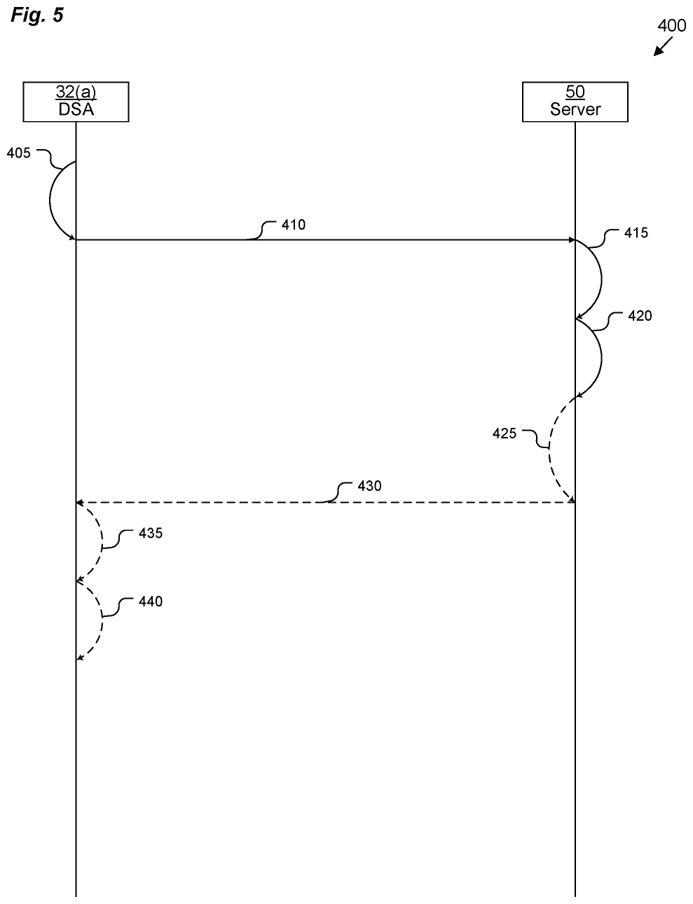

FIG. 5 is a sequence diagram depicting example combined operation 400 of the environment 30. In step 405, a DSA 32(a) operates the reduced-precision neural network 42(a) on its performance metrics 44(a), yielding behavioral estimates 46(a). In step 410, DSA 32(a) sends the performance metrics 44(a) and behavioral estimates 46(a) to the server 50. In step 415, server 50 operates the full-precision neural network 52(a) on the performance metrics 44(a), yielding behavioral estimates 56(a). In step 420, server 50 compares the behavioral estimates 46(a), 56(a), and if they differ significantly, operation proceeds with dashed steps 425-440. In step 425, server 50 generates updated parameters of the reduced-precision neural network 42(a), sending it, in step 430, to the DSA 32(a). In step 435, DSA 32(a) implements the updated parameters in its version of the reduced-precision neural network 42(a). Then, in step 440, DSA 32(a) operates the updated reduced-precision neural network 42(a) going forward.

As used throughout this document, the words “comprising,” “including,” “containing,” and “having” are intended to set forth certain items, steps, elements, or aspects of something in an open-ended fashion. Also, as used herein and unless a specific statement is made to the contrary, the word “set” means one or more of something. This is the case regardless of whether the phrase “set of” is followed by a singular or plural object and regardless of whether it is conjugated with a singular or plural verb. Further, although ordinal expressions, such as “first,” “second,” “third,” and so on, may be used as adjectives herein, such ordinal expressions are used for identification purposes and, unless specifically indicated, are not intended to imply any ordering or sequence. Thus, for example, a “second” event may take place before or after a “first event,” or even if no first event ever occurs. In addition, an identification herein of a particular element, feature, or act as being a “first” such element, feature, or act should not be construed as requiring that there must also be a “second” or other such element, feature or act. Rather, the “first” item may be the only one. Although certain embodiments are disclosed herein, it is understood that these are provided by way of example only and that the invention is not limited to these particular embodiments.

While various embodiments have been particularly shown and described, it will be understood by those skilled in the art that various changes in form and details may be made therein without departing from the spirit and scope of the appended claims.

For example, although various embodiments have been described as being methods, software embodying these methods is also included. Thus, one embodiment includes a tangible non-transitory computer-readable storage medium (such as, for example, a hard disk, a floppy disk, an optical disk, flash memory, etc.) programmed with instructions, which, when performed by a computer or a set of computers, cause one or more of the methods described in various embodiments to be performed. Another embodiment includes a computer that is programmed to perform one or more of the methods described in various embodiments.

Furthermore, it should be understood that all embodiments which have been described may be combined in all possible combinations with each other, except to the extent that such combinations have been explicitly excluded.

What is claimed is:

1. A method performed by a computing device of monitoring storage performance of a remote data storage apparatus (DSA), the method comprising:
receiving performance metrics of the DSA and a first set of behavioral estimates generated by a first neural network (NN) running on the DSA operating on the performance metrics;
operating a second NN on the computing device with the received performance metrics as inputs, the second NN configured to produce a second set of behavioral estimates as outputs in response to the performance metrics, the second NN running at a higher level of precision than the first NN; and
sending to the remote DSA updated parameters of an updated version of the first NN based at least in part on the performance metrics and the first and second sets of behavioral estimates.

2. The method of claim 1 wherein generating the updated version of the first NN includes:
reducing a level of precision of synapse weights from the second NN for use in the updated version of the first NN; and
eliminating synapse weights in the updated version of the first NN having reduced-precision weights of zero.

3. The method of claim 2 wherein generating the updated version of the first NN further includes eliminating, from the first updated version of the first NN, nodes of the second NN whose input synapses have all been eliminated in the updated version of the first NN.

4. The method of claim 3 wherein reducing the level of precision of the synapse weights includes discretizing the synapse weights to zero or one by rounding using a threshold value.

5. The method of claim 2 wherein generating the updated version of the first NN further includes, prior to reducing the level of precision and eliminating synapse weights, replacing the second NN with an updated version of the second NN, based at least in part on the performance metrics and the first and second sets of behavioral estimates.

6. The method of claim 2 wherein generating the updated version of the first NN further includes adding nodes and synapses to the updated version of the first NN yielding a confidence estimate as an output value of the updated version of the first NN.

7. The method of claim 1 wherein the method further includes the computing device monitoring storage performance of a plurality of remote DSAs including the remote DSA by maintaining a pair of NNs for each of the plurality of remote DSAs, each pair of NNs including a full NN and a reduced-precision NN, the full NN running at a higher level of precision than the reduced-precision NN.

8. The method of claim 1 wherein the behavioral estimates include estimates of a data reduction ratio achieved by the remote DSA.

9. The method of claim 1 wherein the behavioral estimates include estimates of a data compression ratio achieved by the remote DSA.

10. The method of claim 1 wherein operating the second NN on the computing device includes operating the second NN on special-purpose processing circuitry configured to operate NNs in an accelerated manner compared to general-purpose processing circuitry.

11. A method performed by a computerized apparatus (apparatus) of monitoring storage performance of the apparatus, the method comprising:
operating a first neural network (NN) on the apparatus with performance metrics of the apparatus as inputs, the first NN configured to produce a first set of behavioral estimates as outputs in response to the performance metrics;
sending the performance metrics and the first set of behavioral estimates to a remote computing device configured to run a second NN, the second NN configured to produce a second set of behavioral estimates as outputs in response to the performance metrics, the second NN running at a higher level of precision than the first NN;
receiving updated parameters of the first NN from the remote computing device in response to the remote computing device updating the first NN based at least in part on the performance metrics and the first and second sets of behavioral estimates; and
updating the first NN with the received updated parameters and operating the updated first NN on the apparatus to produce additional behavioral estimates.

12. The method of claim 11 wherein the first NN is configured with nodes and synapses connecting some of the nodes, the synapses all having unity weight.

13. The method of claim 11 wherein the first NN includes fewer nodes than the second NN.

14. The method of claim 11,
wherein the first NN has a first size, the first NN being stored entirely within a cache of the apparatus; and
wherein the second NN has a second size larger than the first size, the second NN exceeding a size of the cache of the apparatus.

15. The method of claim 11,
wherein the first set of behavioral estimates includes a confidence value, the confidence value estimating how accurate the behavioral estimates are in comparison to the second set of behavioral estimates; and
wherein the method further comprises:
evaluating whether the confidence value exceeds a threshold; and
in response to evaluating, selectively:
for a first set of performance metrics for which the confidence value exceeds the threshold, utilizing the first set of behavioral estimates; and
for a second set of performance metrics for which the confidence value does not exceed the threshold:
requesting the second set of behavioral estimates from the remote computing device;
refraining from utilizing the first set of behavioral estimates; and
utilizing the second set of behavioral estimates as received from the remote computing device.

16. The method of claim 15 wherein utilizing the first set of behavioral estimates includes informing a user of the apparatus of values of the first set of behavioral estimates.

17. The method of claim 15 wherein utilizing the first set of behavioral estimates includes throttling intake of write commands based in part on a data reduction ratio of the first set of behavioral estimates.

18. A system including:
a plurality of computerized data storage apparatuses (DSAs); and
a remote computing device remote from the DSAs;
wherein each DSA is configured to:
operate a first neural network (NN) on that DSA with performance metrics of that DSA as inputs, the first NN configured to produce a first set of behavioral estimates as outputs in response to the performance metrics;
send the performance metrics and the first set of behavioral estimates to the remote computing device;
receive updated parameters of the first NN from the remote computing device; and
update the first NN with the received updated parameters and operate the updated first NN on that DSA to produce additional behavioral estimates; and
wherein the remote computing device is configured to, for each DSA:
receive the performance metrics and the first set of behavioral estimates from that DSA;
operate a second NN for that DSA with the received performance metrics as inputs, the second NN configured to produce a second set of behavioral estimates as outputs in response to the performance metrics, the second NN running at a higher level of precision than the first NN; and
send to that DSA updated parameters of an updated version of the first NN based at least in part on the performance metrics and the first and second sets of behavioral estimates.
